(19) United States
(12) Patent Application Publication
(10) Pub. No.: US 2009/0078907 A1
(43) Pub. Date: Mar. 26, 2009

(54) COMPOSITE VALVE ASSEMBLY FOR AIRCRAFT ENVIRONMENTAL CONTROL SYSTEMS

(75) Inventors: Eric J. Ekstrom, Peoria, AZ (US); Gary E. Armstrong, Mesa, AZ (US); Raul Velasquez, El Mirage, AZ (US); John A. Vasquez, Chandler, AZ (US); Jason D. Mork, Chandler, AZ (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 11/861,930

(22) Filed: Sep. 26, 2007

(51) Int. Cl. F16K 27/00

(52) U.S. Cl. 251/368

(57) ABSTRACT

A valve assembly is provided including an injection molded flow body having at least one inlet port, at least one outlet port, and a flow passage there between. The injection molded flow body is formed of a high performance engineering thermoplastic resin. A plurality of reinforcement fibers may be homogeneously suspended in the high performance engineering thermoplastic resin and provide increased strength and temperature capability for use in high temperature applications.

### FIELD OF THE INVENTION

The present invention generally relates to a valve assembly and, more particularly, to a composite valve flow body for use in conjunction with aircraft environmental control systems.

### BACKGROUND OF THE INVENTION

Many relatively large turbine engines use pneumatic valves to control fluid flow. Some specific examples of pneumatic valves utilized in turbine engines include high stage bleed air valves, mid-stage bleed air valves, bleed air isolation valves, pressure regulating and shutoff valves, load control valves, anti-ice valves, trim air valves, and temperature control valves.

In one specific example, pressure regulating, temperature modulating, and flow control valves may be coupled to a high pressure fluid source such as compressed air taken directly from a turbofan jet engine or an electrically driven turbocompressor for use in environmental control systems (ECS) of aircraft, including heating, ventilating, and air conditioning (HVAC) systems.

It is well-known that pneumatic valve assemblies may be partially disposed within an airway to control flow of a fluid (e.g., air) and thus perform any one of a number of functions (e.g., temperature regulation). Valve assemblies of this type typically comprise a valve (e.g., a butterfly valve), including a metallic flowbody, that is coupled by way of a linkage assembly to an actuator. Aircraft original equipment manufacturers (OEMs) and airline operators are in need of new generation aircraft that are more fuel efficient and provide a lower life cycle cost. This need places a premium on reducing component weight and cost simultaneously. Typically, the need for weight reduction flows down from OEMs to their equipment suppliers to come up with innovative methods in product design to achieve reduced weight and cost.

In the environmental control system (ECS) pack bay of commercial aircraft, which is an unpressurized and non-temperature controlled environment, the use of lightweight materials in structural applications, such as valve flow bodies, has not been achieved. These types of valve flow bodies are viewed as structurally critical components because the postulated failure of such poses a risk of aircraft cabin depressurization and can be a cause of non-compliance with a minimum equipment list.

It should thus be appreciated from the above that it would be desirable to provide an improved valve flow body for use in an environmental control system (ECS) of an aircraft that is fabricated to reduce the component weight using simplified, cost effective fabrication techniques. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

There has now been developed a composite valve assembly comprised of an injection molded flow body having at least one inlet port, at least one outlet port. A flow passage is formed there between. The injection molded flow body is formed of a high performance engineering thermoplastic resin. The valve assembly further includes an electrical bonding connection coupled to the injection molded flow body to a bonding path between the injection molded flow body and an external ground point.

In a further embodiment, still by way of example only, there is provided a composite valve assembly for an environmental control system (ECS) comprised of an injection molded flow body having at least one inlet port, at least one outlet port, and a flow passage there between. The injection molded flow body is formed of a high performance engineering thermoplastic resin selected from a group consisting of: polyetheretherketone (PEEK), polyphenylenesulfide (PPS), polyetherimide (PEI), and polyethersulfone (PES). The valve assembly further includes an electrical bonding connection coupled to the injection molded flow body and providing a bonding path between the injection molded flow body and an external ground point.

In still a further embodiment, and still by way of example only, there is provided a composite valve assembly for environmental control systems (ECS) of an aircraft comprised of an injection molded flow body having at least one inlet port, at least one outlet port, and a flow passage there between. The injection molded flow body is formed of a high performance engineering thermoplastic resin selected from a group consisting of: polyetheretherketones (PEEK), polyphenylenesulfide (PPS), polyetherimide (PEI), and polyethersulfone (PES) and a plurality of fiber reinforcements homogenously suspended therein the high performance engineering thermoplastic resin. The valve assembly further includes an electrical bonding connection coupled to the injection molded flow body and providing a bonding path between the injection molded flow body and an external ground point.

Other independent features and advantages of the improved composite valve assembly will become apparent from the following detailed description, taken in conjunction with the accompanying drawings which illustrate, by way of example, the principles of the invention.

### BRIEF DESCRIPTION OF THE DRAWINGS

The present invention will hereinafter be described in conjunction with the following drawing figures, wherein like numerals denote like elements, and:

FIG. 1 is a simplified isometric view of a portion of a pneumatic valve assembly according to a first embodiment; and

FIG. 2 is a cross-sectional diagram of a portion of the pneumatic valve assembly taken along line 2-2 of FIG. 1.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background or the following detailed description. It should be understood that although the valve assembly is described in conjunction with a turbofan jet engine, it may also be used in any application where a valve assembly is utilized. It should additionally be understood that use of the term “pneumatic” may be interpreted as describing the fluid medium flowing through a pressure vessel, but may also be used to describe the means of actuation of a valve. It should additionally be understood that anticipated by this disclosure is the inclusion of electric, hydraulic, and manual valve actuation.

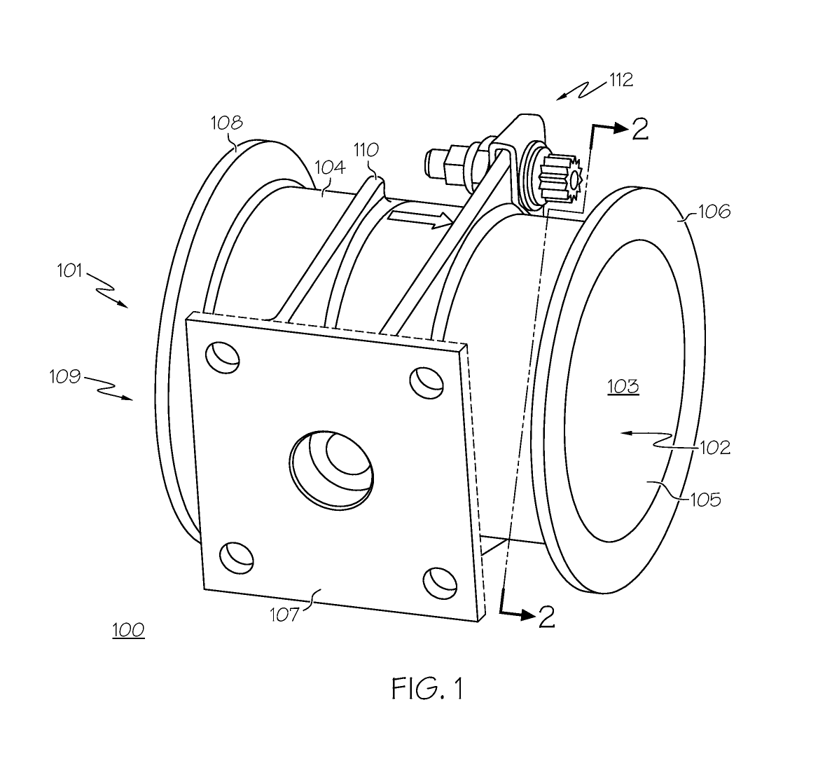

FIG. 1 is a simplified isometric view of a portion of a valve assembly 100. The valve assembly 100 is configured to control the flow of a fluid (e.g., pressurized air) through a flow body 102 defined by a valve housing. The flow body 102 includes an inlet port 101, an outlet port 109, and a flow passage 103 defined there between. It should be understood that while the described embodiment includes simply an inlet port 101 and an outlet port 109, that any number of inlet and outlet ports can be included dependent upon valve design. The valve assembly 100 may be pneumatically operated with a source of pressurized air. Typically, the valve assembly 100 will include an electromechanical actuator assembly (not shown) that is mounted to the flow body 102 at a mounting plate 107. Those having ordinary skill in the art will appreciate from the description that follows that the exact form of the actuator, whether electromechanical, or otherwise, forms no part of the present invention. A valve closure element (not shown) is typically disposed within the valve housing, and more particularly the flow body 102. The valve closure element is coupled to the actuator assembly, and is configured to move between a closed position and an open position. In the closed position, the valve closure element substantially prevents airflow through the flow body 102. In contrast, when the valve closure element is in an open position, air may flow through the flow body 102.

The flow body 102 further includes an inlet flange 108 and an outlet flange 106 at opposed ends of the flow body 102. The flanges 106 and 108 provide a means for attachment to additional components (not shown) such as ducting. The flow body 102 may include a plurality of support ribs 110 protruding generally perpendicular from the flow body 102. At least one of the plurality of support ribs 110, has attached thereto, or formed therein, an electrical bonding connection 112 that provides a bonding connection between the valve flow body 102 and an aircraft current return network (CRN) or other point of grounding. To achieve bonding, or grounding, of the valve assembly 100, a non-illustrated grounding strap, or some other type of bonding, or grounding, means is coupled to the electrical bonding connection 112 to allow a bond path to exist between the flow body 102 and the CRN or other ground point.

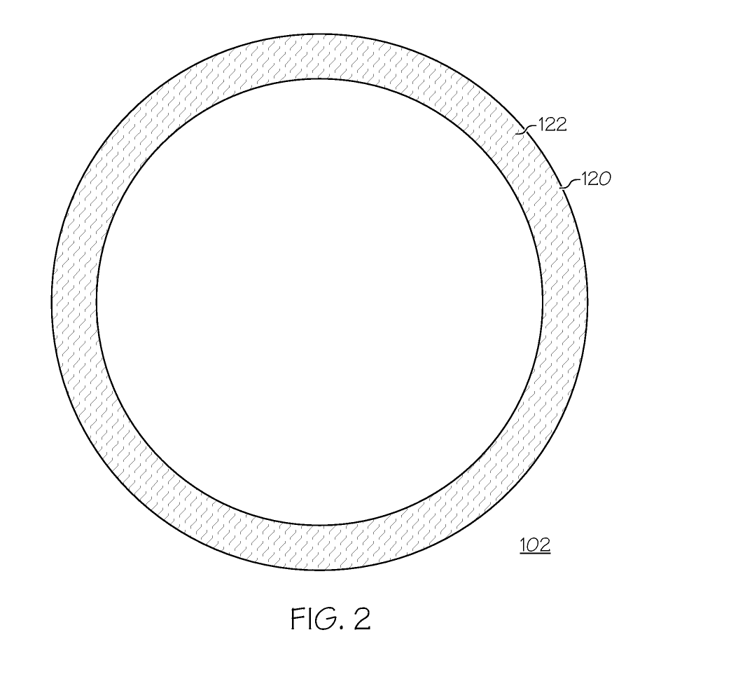

Referring now to FIG. 2, illustrated in a simplified cross-section view take along line 2-2 of FIG. 1, is a portion of the flow body 102. In this particular embodiment, the flow body 102 is formed of a fiber reinforced composite material. More specifically, the flow body 102 is formed of a material that provides for an ECS structural body in the pack bay environment while achieving up to an approximate 50% reduction in weight as compared to one formed of a metallic alloy.

As previously stated the flow body 102 is formed of a composite material such as conductive thermoplastic having low surface and volume resistivity. More specifically, flow body 102 is formed of a high performance engineering thermoplastic resin 120. High performance engineering thermoplastic resins are well known in the art and may include polyetheretherketones (PEEK), polyphenylenesulfide (PPS), polyetherimide (PEI) and polyethersulfone (PES). In a preferred embodiment the high performance engineering thermoplastic resin 120 is formed of polyetheretherketone (PEEK) having homogeneously suspended therein a plurality of fiber reinforcements 122. Materials that are suitable for the plurality of fiber reinforcements 122 and fabrication of the flow body 102 include, but are not limited to, carbon fibers (graphite) and glass fibers. In this preferred embodiment, the flow body 102 is formed of a PEEK resin material and includes approximately 5-40% by volume fiber reinforcements, and more particularly 5-40% by volume carbon fibers, and preferably 28-32% by volume carbon fibers. The flow body 102 is fabricated using traditional injection molded processes. In contrast to prior composite valve components, fabrication of flow body 102 using injection molding processes eliminates many of the fabrication steps of embedding conductive meshes, or the like, and results in overall reduced production costs.

In alternative embodiments, the flow body 102 may be formed of any combination of a high performance engineering thermoplastic resin from the group consisting of: polyetheretherketones (PEEK), polyphenylenesulfide (PPS), polyetherimide (PEI) and polyethersulfone (PES). The flow body 102 may be formed simply of the high performance thermoplastic resin, without the inclusion of any fiber reinforcements, or may include fiber reinforcements chosen from the group consisting of: carbon (graphite) fibers or glass fibers. Typically, when the flow body 102 includes the fiber reinforcements, it results in increased strength and temperature capability and allows for use in high temperature applications. To achieve this increased strength and temperature capability it will include from 5%-40% by volume of one of the carbon (graphite) or glass fibers as an additive to the virgin resin matrices, and preferably 28-32% by volume. Although, the inclusion of the fiber reinforcements is optional, the inclusion of the fiber reinforcement's results in a dispersed reinforced resin matrix with improved strength and temperature capability that promotes survival in high temperature environments, such as that found in environmental control systems.

Accordingly, disclosed is an improved composite valve flow body for use in environmental control systems (ECS) of aircraft. While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A composite valve assembly comprising:
an injection molded flow body having at least one inlet port, at least one outlet port, and a flow passage there between, the injection molded flow body formed of a high performance engineering thermoplastic resin; and
an electrical bonding connection coupled to the injection molded flow body and providing a bonding path between the injection molded flow body and an external ground point.

2. The composite valve assembly of claim 1, wherein the high performance engineering thermoplastic resin is selected from a group consisting of: polyetheretherketone (PEEK), polyphenylenesulfide (PPS), polyetherimide (PEI), and polyethersulfone (PES).

3. The composite valve assembly of claim 1, further including a plurality of fiber reinforcements suspended therein the high performance engineering thermoplastic resin.

4. The composite valve assembly as claimed in claim 3, wherein the plurality of fiber reinforcements are selected from a group consisting of: carbon (graphite) fibers and glass fibers.

5. The composite valve assembly as claimed in claim 3, wherein the injection molded flow body is comprised of polyetheretherketone (PEEK) including 5-40% by volume of fiber reinforcements suspended therein.

6. The composite valve assembly as claimed in claim 5, wherein the injection molded flow body is comprised of polyetheretherketone (PEEK) including 28-32% by volume of fiber reinforcements suspended therein.

7. The composite valve assembly as claimed in claim 6, wherein the fiber reinforcements are carbon (graphite) fibers.

8. A composite valve assembly for an environmental control system (ECS) comprising:
an injection molded flow body having at least one inlet port, at least one outlet port, and a flow passage there between, the injection molded flow body formed of a high performance engineering thermoplastic resin selected from a group consisting of: polyetheretherketone (PEEK), polyphenylenesulfide (PPS), polyetherimide (PEI), and polyethersulfone (PES); and
an electrical bonding connection coupled to the injection molded flow body and providing a bonding path between the injection molded flow body and an external ground point.

9. The composite valve assembly of claim 8, further including a plurality of fiber reinforcements homogenously suspended therein the high performance engineering thermoplastic resin.

10. The composite valve assembly as claimed in claim 9, wherein the plurality of fiber reinforcements are selected from the group consisting of: carbon (graphite) fibers and glass fibers.

11. The composite valve assembly as claimed in claim 9, wherein the injection molded flow body is comprised of polyetheretherketone (PEEK) including 5%-40% by volume of fiber reinforcements suspended therein.

12. The composite valve assembly as claimed in claim 11, wherein the injection molded flow body is comprise of polyetheretherketone (PEEK) including 28-32% by volume of fiber reinforcements suspended therein.

13. The composite valve assembly as claimed in claim 12, wherein the fiber reinforcements are carbon (graphite) fibers.

14. The composite valve assembly as claimed in claim 9, wherein the injection molded flow body is comprised of polyphenylenesulfide (PPS) including 5%-40% by volume of fiber reinforcements suspended therein.

15. The composite valve assembly as claimed in claim 9, wherein the injection molded flow body is comprised of polyetherimide (PEI) including 5%-40% by volume of fiber reinforcements suspended therein.

16. The composite valve assembly as claimed in claim 9, wherein the injection molded flow body is comprised of polyethersulfone (PES) including 5%-40% by volume of fiber reinforcements suspended therein.

17. A composite valve assembly for environmental control systems (ECS) of an aircraft comprising:
an injection molded flow body having at least one inlet port, at least one outlet port, and a flow passage there between, the injection molded flow body formed of a high performance engineering thermoplastic resin selected from a group consisting of: polyetheretherketones (PEEK), polyphenylenesulfide (PPS), polyetherimide (PEI), and polyethersulfone (PES) and a plurality of fiber reinforcements homogenously suspended therein the high performance engineering thermoplastic resin; and
an electrical bonding connection coupled to the injection molded flow body and providing a bonding path between the injection molded flow body and an external ground point.

18. The composite valve assembly as claimed in claim 17, wherein the plurality of fiber reinforcements are selected from a group consisting of: carbon (graphite) fibers and glass fibers.

19. The composite valve assembly as claimed in claim 18, wherein the injection molded flow body includes 5-40% by volume of fiber reinforcements suspended therein.

20. The composite valve assembly as claimed in claim 19, wherein the injection molded flow body includes 28-32% by volume of fiber reinforcements suspended therein.
